(19) United States
(12) Patent Application Publication
(10) Pub. No.: US 2007/0091949 A1
(43) Pub. Date: Apr. 26, 2007

(54) Solid-state laser apparatus having sintered polycrystalline inorganic gain medium

(75) Inventor: Takashi Adachi, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/583,731

(22) Filed: Oct. 20, 2006

(30) Foreign Application Priority Data
Oct. 20, 2005 (JP) 305437/2005

(51) Int. Cl. H01S 3/14

(52) U.S. Cl. 372/39

(57) ABSTRACT

In a laser-diode-excited laser apparatus: an excitation light source realized by one or more semiconductor lasers emit first laser light having a first wavelength; and a gain medium is excited by the first laser light, and oscillates second laser light having a second wavelength different from the first wavelength. Each semiconductor laser is a semiconductor laser having an oscillation peak wavelength of 350 to 550 nm (e.g., a nitride-based semiconductor laser). The gain medium is a sintered transparent polycrystalline inorganic body.

### BACKGROUND OF THE INVENTION

1. Field of the Invention

The present invention relates to a solid-state laser apparatus which is constituted by a gain medium and an excitation light source realized by a semiconductor laser, and emits laser light having a wavelength different from the oscillation wavelength of the semiconductor laser by exciting the gain medium with laser light emitted from the semiconductor laser. In particular, the present invention relates to a solid-state laser apparatus which emits laser light in the visible and ultraviolet wavelength range.

2. Description of the Related Art

Conventionally, semiconductor-laser-excited solid-state laser apparatuses in which a gain medium is excited with laser light emitted from a semiconductor laser as an excitation light source are known.

For example, in the solid-state laser apparatuses disclosed in U.S. Pat. No. 6,125,132, European Laid-Open No. 1162705, and Japanese Unexamined Patent Publication No. 2004-356479, a nitride-based (e.g., GaN-based) semiconductor laser emitting laser light in the visible and ultraviolet wavelength range of 350 to 550 nm is used as an excitation light source, and a solid laser crystal doped with ions of one or more of rare-earth elements and transition-metal elements which realize radiative centers in a gain medium is used as the gain medium.

As indicated in U.S. Pat. No. 6,125,132, Pr ions, which realize a plurality of emission peaks in the visible wavelength range, are receiving attention as the ions with which the gain medium is to be doped for producing radiative centers in the gain medium. An example of a material which is expected to be a host compound to be doped with Pr ions is Y₃Al₅O₁₂ (YAG) since YAG is superior in thermal stability.

In the case where YAG is doped with Pr ions, part of Y³⁺ ions at A sites are substituted with Pr³⁺ ions by solid solution. However, the ion radius r1 (=0.1019 nm) of the Y³⁺ ions at A sites is smaller than the ion radius r2 (=0.1126 nm) of the Pr³⁺ ions at A sites (i.e., r1<r2) . Therefore, the segregation coefficient in the doping of YAG with Pr ions is approximately zero, so that the solid solution of Pr in YAG is extremely difficult. Thus, high concentration doping with Pr ions is difficult, and the concentration of the Pr ions is at most 0.5 mol %. When the dopant concentration in a solid laser crystal is 0.5 mol % or smaller, the absorption coefficient of the solid laser crystal is less than 1 cm⁻¹, so that it is difficult to generate laser light in the visible wavelength range with high efficiency.

It is possible to increase the absorption efficiency of the gain medium and the efficiency of the solid-state laser apparatus by increasing the length of the Pr-doped solid laser crystal. In the solid-state laser apparatus, the solid laser crystal can be excited by injecting excitation laser light through either the end face or one or more side faces of the crystal (i.e., the solid laser crystal can be excited by either the longitudinal excitation or the transverse excitation). When the length of the crystal is increased in the solid-state laser apparatus, whichever of the longitudinal excitation and the transverse excitation is used, the region in which the excitation light is absorbed does not coincide with the diameter of the oscillated laser beam, so that the mode matching efficiency is lowered, and the efficiency of the solid-state laser apparatus cannot be increased.

Even if the absorption efficiency of the Pr-doped solid laser crystal is low, it is possible to increase the output power of the solid-state laser apparatus by increasing the output power of the excitation light source. However, when the output power of the excitation light source is increased, the size or cost of the excitation light source increases. Therefore, it is not preferable to increase the output power of the excitation light source.

U.S. Pat. No. 6,125,132, European Laid-Open No. 1162705, and Japanese Unexamined Patent Publication No. 2004-356479 disclose use of a crystal as a gain medium, and do not refer to use of a polycrystalline gain medium. Therefore, it is appropriate to consider that the term “crystal” means a monocrystal in U.S. Pat. No. 6,125,132, European Laid-Open No. 1162705, and Japanese Unexamined Patent Publication No. 2004-356479. However, the monocrystals, including the Pr-doped solid laser crystal, are expensive, and it is difficult to increase the sizes of monocrystals. Although it is particularly difficult to dope a solid laser crystal with Pr ions as mentioned before, there is a general tendency that high-concentration doping of a monocrystal with the other ions for realizing radiative centers is also difficult.

In addition, in the case where ultraviolet light is obtained by converting the wavelength of the output of the conventional solid-state laser apparatus by using a wavelength conversion element, it is difficult to increase the efficiency of the solid-state laser apparatus and the output power of the ultraviolet light.

Under the above circumstances, currently no practical solid-state laser apparatus can emit laser light in the visible and ultraviolet wavelength range with high efficiency and be produced at low cost.

Further, A. Ikesue et al., “Synthesis of Pr Heavily-Doped, Transparent YAG Ceramics,” Journal of the Ceramic Society of Japan, vol. 109, Issue 7, pp. 640-642, 2001 reports that it is possible to achieve a higher doping concentration (specifically, 4.3 mol %) of Pr ions in a sintered polycrystalline YAG body than in a monocrystal. However, the Ikesue reference shows only a result of a basic scientific research on the Pr-doped YAG material, and does not refer to application to a solid-state laser apparatus, much less application to a solid-state laser apparatus using a nitride-based semiconductor laser as an excitation light source.

### SUMMARY OF THE INVENTION

The present invention has been developed in view of the above circumstances.

The object of the present invention is to provide a solid-state laser apparatus which can emit laser light in the visible and ultraviolet wavelength range with high efficiency and high output power, and can be produced at low cost without increasing the size of the solid-state laser apparatus.

In order to accomplish the above object, the first aspect of the present invention is provided. According to the first aspect of the present invention, there is provided a solid-state laser apparatus comprising: an excitation light source which is realized by one or more semiconductor lasers, and emits first laser light having a first wavelength; and a gain medium which is excited by the first laser light, and oscillates second laser light having a second wavelength different from the first wavelength. The one or more semiconductor lasers have an oscillation peak wavelength of 350 to 550 nm, and the gain medium is realized by a sintered transparent polycrystalline inorganic body.

In addition, in order to accomplish the aforementioned object, the second aspect of the present invention is also provided. According to the second aspect of the present invention, there is provided a solid-state laser apparatus comprising: an excitation light source which is realized by one or more semiconductor lasers, and emits first laser light having a first wavelength; and a gain medium which is excited by the first laser light, and oscillates second laser light having a second wavelength different from the first wavelength. The one or more semiconductor lasers are one or more nitride-based semiconductor lasers, and the gain medium is a sintered transparent polycrystalline inorganic body. The nitride-based semiconductor lasers have an oscillation peak wavelength in the range of 350 to 550 nm.

Preferably, the solid-state laser apparatuses according to the first and second aspects of the present invention may also have one or any possible combination of the following additional features (i) to (v).
(i) The one or more semiconductor lasers are one or more GaN-based semiconductor lasers.
(ii) The gain medium is realized by an inorganic material, which is one of a garnet-type compound, a C-type rare earth compound, and a perovskite-type compound, where the gain medium may contain inevitable impurities.
(iii) The gain medium is realized by an inorganic material doped with ions of one or more of rare-earth elements and transition-metal elements which realize radiative centers in the gain medium, where the gain medium may contain inevitable impurities.
(iv) The one or more of rare-earth elements and transition-metal elements in the feature (iii) are one or more of Ce, Pr, Nd, Pm, Sm, Eu, Gd, Tb, Dy, Ho, Er, Tm, Cr, and Ti.
(v) The solid-state laser apparatuses according to the first and second aspects of the present invention may further comprise one or more wavelength conversion elements which are arranged in a stage following the gain medium, and convert the second wavelength of the second laser light into a third wavelength. That is, the solid-state laser apparatuses according to the first and second aspects of the present invention can further comprise one or more wavelength conversion elements as above when necessary.

The solid-state laser apparatuses according to the first and second aspects of the present invention have the following advantages.

As described before, the solid-state laser apparatuses according to the first and second aspects of the present invention are constituted by one or more semiconductor lasers having an oscillation peak wavelength of 350 to 550 nm or one or more nitride-based semiconductor lasers, and a gain medium is realized by a sintered transparent polycrystalline inorganic body. Therefore, the solid-state laser apparatuses according to the first and second aspects of the present invention can emit laser light in the visible and ultraviolet wavelength range.

In addition, since the sintered transparent polycrystalline inorganic body as the gain medium can be produced very easily, compared with the monocrystalline gain medium, the sintered transparent polycrystalline inorganic body can be doped with a higher concentration of ions realizing radiative centers than the monocrystalline gain medium. Therefore, according to the present invention, it is possible to achieve high-concentration doping with ions which realize radiative centers. The high-concentration doping with such ions increases the absorption of the excitation light in the gain medium and the output power of the gain medium without increasing the size of the gain medium. Thus, the efficiency and the output power of the solid-state laser apparatus are increased according to the present invention.

In addition, since the sintered transparent polycrystalline inorganic body as the gain medium can be produced easily, compared with the monocrystalline gain medium, the gain medium realized by the sintered transparent polycrystalline inorganic body can be produced in a greater size than the monocrystalline gain medium. When the size of the gain medium is increased, the efficiency and the output power of the solid-state laser apparatus also increase.

Further, the gain medium realized by the sintered transparent polycrystalline inorganic body is less expensive than the monocrystalline gain medium. In addition, since laser light with high output power can be obtained without increasing the size of the excitation light source, it is possible to use a smaller (less expensive) excitation light source.

As explained above, the solid-state laser apparatuses according to the first and second aspects of the present invention can emit laser light in the visible and ultraviolet wavelength range with high efficiency and high output power, and can be produced in a small size at low cost.

### DESCRIPTION OF THE DRAWINGS

FIG. 1 is a schematic side view illustrating the solid-state laser apparatus according to a first embodiment of the present invention.

FIG. 2 is a schematic side view illustrating the solid-state laser apparatus according to a second embodiment of the present invention.

FIG. 3 is a schematic side view illustrating a first variation of the solid-state laser apparatus according to the first embodiment of the present invention.

FIG. 4 is a schematic side view illustrating a second variation of the solid-state laser apparatus according to the first embodiment of the present invention.

### DESCRIPTION OF PREFERRED EMBODIMENTS

Embodiments of the present invention are explained in detail below with reference to drawings.

### First Embodiment

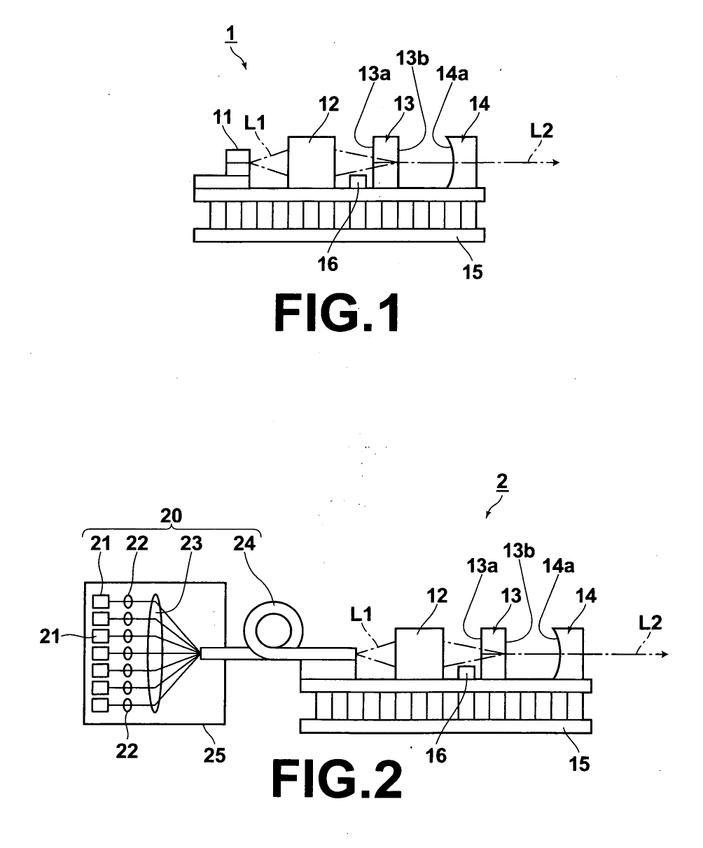

The solid-state laser apparatus according to a first embodiment of the present invention is explained below with reference to FIG. 1, which is a schematic side view illustrating the solid-state laser apparatus 1 according to the first embodiment.

The solid-state laser apparatus 1 of FIG. 1 comprises a semiconductor laser 11, a condensing lens 12, a gain medium 13, an output mirror 14, a Peltier element 15, and a thermistor 16. The semiconductor laser 11, the condensing lens 12, the gain medium 13, the output mirror 14, and the thermistor 16 are fixed on the Peltier element 15.

The semiconductor laser 11 realizes an excitation light source, and emits laser light L1 as excitation light, where the laser light L1 is a divergent light beam. The gain medium 13 is excited with the laser light L1, and oscillates laser light having a wavelength different from the wavelength of the laser light L1. The condensing lens 12 is arranged between the semiconductor laser 11 and the gain medium 13, and condenses the laser light L1. The output mirror 14 is arranged in a stage following the gain medium 13. The thermistor 16 detects the temperature, and the Peltier element 15 is actuated by a temperature control circuit (not shown) on the basis of the output of the thermistor 16 so that the temperature of the semiconductor laser 11, the condensing lenses 12, the gain medium 13, and the output mirror 14 is maintained at a predetermined level. Alternatively, it is possible to fix the semiconductor laser 11, the condensing lenses 12, the gain medium 13, and the output mirror 14 on the thermistor 16 through a holder made of metal such as copper.

The excitation-light incident surface 13a of the gain medium 13 is coated so that the excitation light satisfactorily passes through the coating (preferably with the reflectance of 1% or smaller), and laser light having an output wavelength is satisfactorily reflected by the coating (preferably with the reflectance of 99% or greater). Preferably, the coating applied to the excitation-light incident surface 13a exhibits a reflectance of 1% or smaller at the wavelength of the excitation light, and a reflectance of 99% or greater at the output wavelength. In addition, the emission-light exit surface 13b of the gain medium 13 is coated so that laser light having the output wavelength satisfactorily passes through the coating. Preferably, the coating applied to the emission-light exit surface 13b exhibits a reflectance of 1% or smaller at the output wavelength.

The output mirror 14 has a concave light-incident surface 14a, which is coated so that a portion of laser light having the output wavelength satisfactorily passes through the coating, and the other light is reflected. For example, the coating applied to the light-incident surface 14a exhibits a reflectance of 2% at the output wavelength.

The gain medium 13 and the output mirror 14 are arranged so that a resonator is formed between the excitation-light incident surface 13a and the light-incident surface 14a, and laser light L2 having the specific wavelength (i.e., the output wavelength) is outputted through the output mirror 14 as output light.

In this embodiment, the semiconductor laser 11 is a nitride-based semiconductor laser which comprises an active layer containing one or more nitrogen-containing semiconductor compounds such as GaN, InGaN, or AlGaN. Such a semiconductor laser has an oscillation peak wavelength in the wavelength range of 350 to 550 nm. The semiconductor laser 11 may be either the single-transverse-mode type or the broad-area type.

The gain medium 13 is a sintered transparent polycrystalline inorganic body. The composition of the gain medium 13 is not specifically limited as far as the gain medium 13 can be excited with the excitation light source, and emit light having a wavelength different from the wavelength of the excitation light. Preferable examples of the composition of the gain medium 13 are indicated below.

Preferably, the gain medium 13 is realized by an inorganic material, which is one of a garnet-type compound, a C-type rare earth compound, and a perovskite-type compound. The gain medium 13 may contain inevitable impurities. In particular, it is preferable to realize the gain medium 13 by an inorganic material doped with ions of one or more of rare-earth elements and transition-metal elements which realize radiative centers in the gain medium 13, where the gain medium 13 may contain inevitable impurities. The one or more of rare-earth elements and transition-metal elements are preferably one or more of Ce, Pr, Nd, Pm, Sm, Eu, Gd, Tb, Dy, Ho, Er, Tm, Cr, and Ti.

A preferable example of the gain medium 13 is made by doping a host material such as YAG (Y₃Al₅O₁₂) with Pr ions. Since YAG is superior in thermal stability, YAG is suitable for the host material of the gain medium 13. In addition, since the Pr ions realize a plurality of emission peaks in the visible wavelength range, it is preferable to dope the host material with the Pr ions, which produce radiative centers. Further, it is possible to codope the host material with the Pr ions and ions of one or more of the Nd, Pm, Sm, Eu, Dy, Ho, and Er.

Hereinbelow, exemplary cases where the gain medium 13 is realized by Pr-doped YAG (Pr-YAG) are explained.

As mentioned before, it is difficult to dope YAG with Pr. However, according to the first embodiment, the gain medium 13 is realized by the sintered transparent polycrystalline inorganic body. Therefore, the gain medium 13 is easier to be doped with Pr ions than the monocrystalline gain medium, so that the sintered transparent polycrystalline inorganic body can be doped with a higher concentration of Pr ions than the monocrystalline gain medium. From the viewpoint of the emission intensity (fluorescence intensity), the doped amount is preferably 1.0 to 4.0 mol %, and is, for example, 2.0 mol %. Hereinafter, for example, YAG doped with 2.0 mol % Pr is referred to as 2.0% Pr-YAG.

The sintered polycrystalline body of Pr-YAG can be produced, for example, as follows.

First, Y₂O₃ powder, α-Al₂O₃ powder, and Pr₆O₁₁ powder as raw materials are weighed out so as to realize a desired composition, put into a pot mill together with ethyl alcohol and alumina balls, and wet mixed together. Next, the alumina balls are removed so as to obtain mixed powder slurry, and then the ethyl alcohol in the mixed powder slurry is removed by using a rotary evaporator. Thereafter, the remaining mixed powder is dried for 12 hours, and then the dried powder is lightly loosened in a mortar. Subsequently, the dried powder is molded by uniaxial compression into a desired shape so as to produce a compression-molded body. Next, the compression-molded body undergoes a prebaking process. In the prebaking process, the compression-molded body is placed in the atmosphere in an electric furnace, heated at the heating rate of 500° C./hour until the temperature reaches 1450° C., maintained at 1450° C. for two hours, cooled at the cooling rate of 500° C./hour until the temperature reaches 1000° C., and naturally cooled in the electric furnace. After the prebaking process, the compression-molded body is pulverized in a mortar, and remolded by uniaxial compression. Then, the remolded body undergoes a sintering process. In the sintering process, the remolded body is placed at the vacuum pressure of 1.3×10⁻³ Pa or lower in an vacuum sintering furnace, heated at the heating rate of 500° C./hour until the temperature reaches 1750° C., maintained at 1750° C. for 20 hours, cooled at the cooling rate of 500° C./hour until the temperature reaches 1000° C., and naturally cooled in the vacuum sintering furnace. Thus, a sintered polycrystalline body of Pr-YAG is obtained.

In addition, sintered polycrystalline bodies of materials other than Pr-YAG can also be produced in similar manners.

The absorption peak wavelength of Pr (i.e., the wavelength of excitation light at which the emission intensity is maximized) is 452 nm. In the case where the gain medium 13 is Pr-YAG, the semiconductor laser 11 is preferably a GaN-based semiconductor laser, which has an oscillation peak wavelength of 370 to 450 nm.

In the case where the excitation wavelength is 452 nm, the emission spectrum (fluorescence spectrum) of Pr-YAG exhibits a strong emission peak at 608 nm. Therefore, it is possible to arrange the solid-state laser apparatus 1 according to the first embodiment (as illustrated in FIG. 1) so that the laser light L2 has the wavelength of 608 nm.

For example, the solid-state laser apparatus 1 according to the first embodiment can be produced under the following design conditions (a) to (d).
(a) The semiconductor laser 11 is a single-transverse-mode GaN-based semiconductor laser having the oscillation peak wavelength of 450 nm and the output power of 50 mW.
(b) The gain medium 13 is 2.0% Pr-YAG having the absorption peak wavelength of 452 nm and the thickness of 2 mm.
(c) The output mirror 14 has the radius of curvature of 50 mm, and is arranged at a distance of 10 mm from the excitation-light incident surface 13a of the gain medium 13.
(d) The laser light L2 has the wavelength of 608 nm.

In the solid-state laser apparatus 1 according to the first embodiment satisfying the above conditions (a) to (d), the oscillation peak wavelength of the semiconductor laser 11 almost coincides with the absorption peak wavelength of the gain medium 13. The present inventor has confirmed that when the solid-state laser apparatus 1 according to the first embodiment satisfies the above conditions (a) to (d), approximately 30% of the excitation light is absorbed in the gain medium 13, and the laser light L2 outputted from the solid-state laser apparatus has output power of approximately 1 mW.

Since Pr-YAG has emission peak wavelengths other than 608 nm, the wavelength of the laser light L2 can be changed to 487 nm, 532 nm, 564 nm, or the like by appropriately changing the coatings applied to the gain medium 13 and the output mirror 14.

In addition, the wavelength of the laser light L2 can be further changed to wavelengths other than the emission peak wavelengths of Pr-YAG by appropriately changing the combination of the compositions of the semiconductor laser 11 and the gain medium 13.

As explained before, in the solid-state laser apparatus 1 according to the first embodiment, the semiconductor laser 11 is a nitride-based semiconductor laser having the oscillation peak wavelength in the range of 350 to 550 nm, and the gain medium 13 is a sintered polycrystalline inorganic body. Therefore, the solid-state laser apparatus 1 according to the first embodiment has the following advantages.
(1) The laser light L2 outputted from the solid-state laser apparatus 1 according to the first embodiment belongs to the visible wavelength range.
(2) The gain medium 13, which is a sintered polycrystalline inorganic body, can be produced very easily, and the gain medium 13 can be doped with a high concentration of ions realizing radiative centers, compared with the monocrystalline gain medium.

In addition, since the gain medium 13 can be doped with a high concentration of ions realizing radiative centers, compared with the monocrystalline gain medium, the gain medium 13 can absorb a greater amount of excitation light than the monocrystalline gain medium having the same size as the gain medium 13, so that the output power of the gain medium 13 is also greater than the output power of the monocrystalline gain medium having the same size as the gain medium 13. Thus, the solid-state laser apparatus 1 according to the first embodiment has higher efficiency and greater output power than the conventional solid-state laser apparatus.

Further, since the production of the gain medium 13 is easier than the production of the monocrystalline gain medium, the gain medium 13 can be produced in a greater size than the monocrystalline gain medium. When the size of the gain medium 13 is increased, the efficiency and the output power of the solid-state laser apparatus also increase.
(3) The gain medium 13 realized by the sintered transparent polycrystalline inorganic body is less expensive than the monocrystalline gain medium. In addition, since the solid-state laser apparatus 1 according to the first embodiment can output laser light having high output power without increasing the size of the excitation light source, it is possible to use a smaller excitation light source, which is less expensive.

As explained above, the solid-state laser apparatus 1 according to the first embodiment can emit laser light L2 in the visible wavelength range with high efficiency and high output power, and can be produced in a small size at low cost.

### Second Embodiment

The solid-state laser apparatus according to a second embodiment of the present invention is explained below with reference to FIG. 2, which is a schematic side view illustrating the solid-state laser apparatus 2 according to the second embodiment. In FIG. 2, elements having the same reference numbers as FIG. 1 have the same functions as the corresponding elements in FIG. 1, and descriptions of the equivalent elements or constituents are not repeated in the following explanations unless necessary.

The solid-state laser apparatus 2 of FIG. 2 is different from the solid-state laser apparatus 1 according to the first embodiment in that the excitation light source in the solid-state laser apparatus 2 is realized by a combined laser module 20 constituted by a plurality of semiconductor lasers 21 while the excitation light source in the solid-state laser apparatus 1 is realized by the single semiconductor laser 11.

Specifically, the combined laser module 20 comprises the plurality of semiconductor lasers 21, a plurality of collimator lenses 22, a condensing lens 23, an optical fiber 24, and a package 25. The collimator lenses 22 are arranged in correspondence with the collimator lenses 22, respectively. That is, the number of the semiconductor lasers 21 is equal to the number of collimator lenses 22. The semiconductor lasers 21, the collimator lenses 22, the condensing lens 23, and a portion of the optical fiber 24 are hermetically sealed in the package 25.

Each of the semiconductor lasers 21 emits a divergent laser beam. Each of the collimator lenses 22 collimates the laser beam emitted from the corresponding one of the semiconductor lasers 21. The condensing lens 23 condenses the laser beams collimated by the collimator lenses 22 so that the condensed laser beams enter and propagate through the optical fiber 24. In the optical fiber 24, the condensed laser beams are optically combined into the laser light L1, which is outputted from the excitation light source as the excitation light for exciting the gain medium 13.

The number of the semiconductor lasers 21 may be appropriately determined according to the design. Each of the semiconductor lasers 21 may be a similar semiconductor laser to the semiconductor laser 11 used in the first embodiment. In the solid-state laser apparatus 2 according to the second embodiment, the combination of the semiconductor lasers 21 and the gain medium 13 can be chosen in a similar manner to the first embodiment.

For example, the solid-state laser apparatus 2 according to the second embodiment can be produced under the following design conditions (a′) to (g′).
(a′) The semiconductor lasers 21 are single-transverse-mode GaN-based semiconductor lasers having the oscillation peak wavelength of 450 nm and the output power of 50 mW.
(b′) The number of the semiconductor lasers 21 is seven.
(c′) The output power of the combined laser module 20 is 250 W.
(d′) The laser light (excitation light) L1 has the wavelength of 450 nm.
(e′) The gain medium 13 is 2.0% Pr-YAG having the absorption peak wavelength of 452 nm and the thickness of 2 mm.
(f′) The output mirror 14 has the radius of curvature of 50 mm, and is arranged at a distance of 10 mm from the excitation-light incident surface 13a of the gain medium 13.
(g′) The laser light L2 has the wavelength of 608 nm.

In the solid-state laser apparatus 2 according to the second embodiment satisfying the above conditions (a′) to (g′), the oscillation peak wavelength of the semiconductor lasers 21 almost coincides with the absorption peak wavelength of the gain medium 13. The present inventor has confirmed that when the solid-state laser apparatus 2 according to the second embodiment satisfies the above conditions (a′) to (g′), approximately 30% of the excitation light is absorbed in the gain medium 13, and the laser light L2 outputted from the solid-state laser apparatus 2 has output power of approximately 10 mW.

Since the solid-state laser apparatus 2 according to the second embodiment is similar to the solid-state laser apparatus 1 according to the first embodiment except that the excitation light source is constituted by the plurality of semiconductor lasers 21, and the combination of the semiconductor lasers 21 and the gain medium 13 is similar to the first embodiment, the solid-state laser apparatus 2 according to the second embodiment has advantages similar to the solid-state laser apparatus 1 according to the first embodiment. That is, the solid-state laser apparatus 2 according to the second embodiment can also emit laser light L2 in the visible wavelength range with high efficiency and high output power, and can be produced in a small size at low cost. In addition, since the excitation light source is constituted by the plurality of semiconductor lasers 21, the solid-state laser apparatus 2 according to the second embodiment can emit laser light L2 with higher output power than the solid-state laser apparatus 1 according to the first embodiment.

Variations and Additional Matters

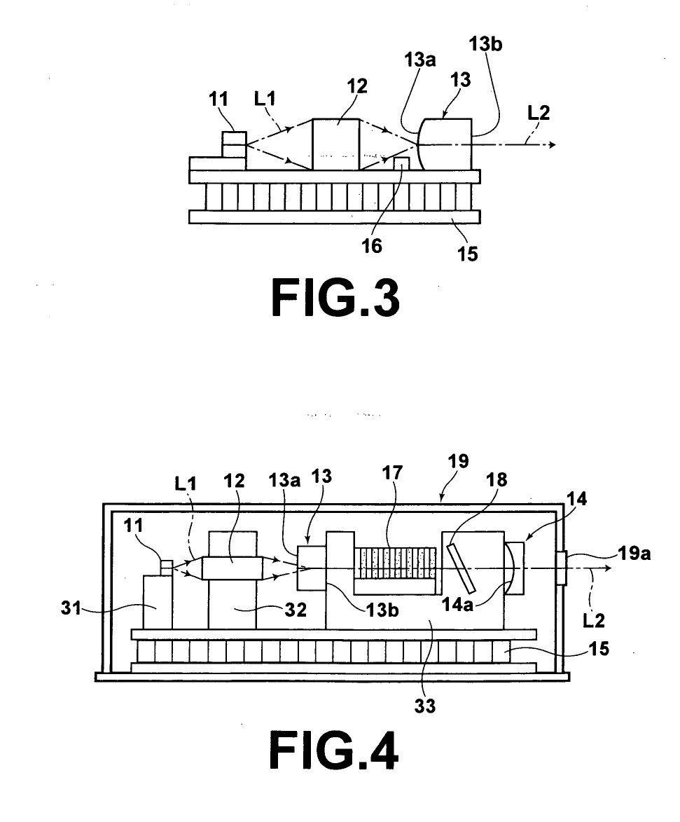

The solid-state laser apparatuses according to the first and second aspects of the present invention are not limited to the first and second embodiments. All suitable modifications and equivalents which will readily occur to those skilled in the art are regarded as falling within the scope of the invention. For example, the solid-state laser apparatuses according to the first and second embodiments can be modified as follows.
(1) The solid-state laser apparatuses according to the first and second embodiments may be equipped with an APC (automatic power control) function. For this purpose, for example, an additional mirror which partially reflects and transmits the laser light L2 is arranged in the stage following the output mirror 14, an optical detection element (such as a photodiode) detects the amount of light which is reflected by or transmits through the additional mirror, and the semiconductor laser 11 or the semiconductor lasers 21 are feedback controlled so that the amount of light detected by the optical detection element is maintained at a constant level.
(2) The resonator can be realized by only the gain medium 13, so that the output mirror 14 can be dispensed with. For this purpose, for example, as illustrated in FIG. 3, the emission-light exit surface 13b of the gain medium 13 is coated in a similar manner to the light-incident surface 14a of the output mirror 14, and one or both of the excitation-light incident surface 13a and the emission-light exit surface 13b of the gain medium 13 are shaped into a curved surface by polishing, dry etching, or the like.
(3) As illustrated in FIG. 4, it is possible to arrange a wavelength conversion element 17 and an etalon 18 between the gain medium 13 and the output mirror 14 in order to convert the wavelength of the laser light oscillated in the gain medium 13.

For example, the wavelength conversion element 17 is made by forming a periodic domain-inverted structure in a nonlinear optical crystal (e.g., a MgO-doped LiTaO₃ crystal), and converts the laser light (e.g., having the wavelength of 608 nm) oscillated by the gain medium 13, into ultraviolet light (e.g., having the wavelength of 304 nm) as the second harmonic wave. Alternatively, it is possible to obtain the third harmonic wave or the fourth harmonic wave by arranging more than one wavelength conversion element. The etalon 18 is a wavelength selection element, and is arranged as above when necessary. When the etalon 18 is arranged, it is possible to oscillate laser light in a single longitudinal mode, and suppress noise. Further, it is also possible to arrange a Brewster plate as a polarization control element.

In the solid-state laser apparatus illustrated in FIG. 4, the semiconductor laser 11 is fixed to the Peltier element 15 through a holder 31, the condensing lenses 12 is fixed to the Peltier element 15 through a holder 32, and the gain medium 13, the wavelength conversion element 17, the etalon 18, and the output mirror 14 are fixed to the Peltier element 15 through a holder 33. In addition, the elements 11 to 14, 17, and 18 are hermetically sealed in a package 19 having a window, in which a window panel 19a is inserted. It is preferable that the package 19 is filled with dry air, nitrogen gas, or the like since contamination and dew condensation can be prevented by filling the package 19 with dry air, nitrogen gas, or the like. When at least the elements forming the resonator are hermetically sealed in the package 19, the contamination can be satisfactorily prevented.

In the case where the wavelength conversion element 17 is arranged in the solid-state laser apparatus as illustrated in FIG. 4, it is possible to easily obtain the laser light L2 in the ultraviolet wavelength range at low cost, so that the solid-state ultraviolet laser apparatus can be reduced in size and produced at low cost. The wavelength conversion element 17 may be made of any crystal which can convert the oscillated light into ultraviolet light (e.g., a crystal of BBO, LBO, CLBO, or KBBF).
(4) Each of the solid-state laser apparatuses illustrated in FIGS. 1, 2, and 3 can also be hermetically sealed in a package as illustrated in FIG. 4.
(5) Although the gain medium 13 is excited by injection of the laser light L1 into the gain medium 13 in the longitudinal direction of the solid-state laser apparatuses illustrated in FIGS. 1 to 4, the gain medium 13 may be excited by one or more semiconductor lasers in any manner. For example, the gain medium 13 may be excited by injecting the laser light L1 from one or more side surfaces of the gain medium 13, or from a direction oblique with respect to the resonator. Alternatively, the gain medium 13 may be excited by causing multiple reflection in the gain medium 13. Further alternatively, it is possible to use a mode locker, and arrange the solid-state laser apparatuses to output pulsed laser light.

What is claimed is:

1. A solid-state laser apparatus comprising:
an excitation light source which is realized by one or more semiconductor lasers, and emits first laser light having a first wavelength; and
a gain medium which is excited by said first laser light, and oscillates second laser light having a second wavelength different from said first wavelength;
wherein said one or more semiconductor lasers have an oscillation peak wavelength of 350 to 550 nm, and
said gain medium is a sintered transparent polycrystalline inorganic body.

2. A solid-state laser apparatus according to claim 1, wherein said one or more semiconductor lasers are one or more GaN-based semiconductor lasers.

3. A solid-state laser apparatus according to claim 1, wherein said gain medium is realized by an inorganic material, which is one of a garnet-type compound, a C-type rare earth compound, and a perovskite-type compound.

4. A solid-state laser apparatus according to claim 1, wherein said gain medium is realized by an inorganic material doped with ions of one or more of rare-earth elements and transition-metal elements which realize radiative centers in the gain medium.

5. A solid-state laser apparatus according to claim 4, wherein said one or more of rare-earth elements and transition-metal elements are one or more of Ce, Pr, Nd, Pm, Sm, Eu, Gd, Tb, Dy, Ho, Er, Tm, Cr, and Ti.

6. A solid-state laser apparatus according to claim 1, further comprising one or more wavelength conversion elements which are arranged in a stage following said gain medium, and convert said second wavelength of said second laser light into a third wavelength.

7. A solid-state laser apparatus comprising:
an excitation light source which is realized by one or more semiconductor lasers, and emits first laser light having a first wavelength; and
a gain medium which is excited by said first laser light, and oscillates second laser light having a second wavelength different from said first wavelength;
wherein said one or more semiconductor lasers are one or more nitride-based semiconductor lasers, and
said gain medium is a sintered transparent polycrystalline inorganic body.

8. A solid-state laser apparatus according to claim 7, wherein said one or more semiconductor lasers are one or more GaN-based semiconductor lasers.

9. A solid-state laser apparatus according to claim 7, wherein said gain medium is realized by an inorganic material, which is one of a garnet-type compound, a C-type rare earth compound, and a perovskite-type compound.

10. A solid-state laser apparatus according to claim 7, wherein said gain medium is realized by an inorganic material doped with ions of one or more of rare-earth elements and transition-metal elements which realize radiative centers in the gain medium.

11. A solid-state laser apparatus according to claim 10, wherein said one or more of rare-earth elements and transition-metal elements are one or more of Ce, Pr, Nd, Pm, Sm, Eu, Gd, Tb, Dy, Ho, Er, Tm, Cr, and Ti.

12. A solid-state laser apparatus according to claim 7, further comprising one or more wavelength conversion elements which are arranged in a stage following said gain medium, and convert said second wavelength of said second laser light into a third wavelength.
